(19) United States
(12) Patent Application Publication
(10) Pub. No.: US 2016/0063144 A1
(43) Pub. Date: Mar. 3, 2016

(54) SYSTEM AND METHOD FOR MODELING HUMAN CROWD BEHAVIOR

(71) Applicants: Gordon Cooke, Warwick, NY (US); Robert DeMarco, Springfield, NJ (US); Elizabeth Mezzacappa, Edison, NJ (US); Gladstone Reid, Clifton, NJ (US); John Riedener, Stanhope, NJ (US); Caitlin Weaver, Lyndhurst, NJ (US)

(72) Inventors: Gordon Cooke, Warwick, NY (US); Robert DeMarco, Springfield, NJ (US); Elizabeth Mezzacappa, Edison, NJ (US); Gladstone Reid, Clifton, NJ (US); John Riedener, Stanhope, NJ (US); Caitlin Weaver, Lyndhurst, NJ (US)

(21) Appl. No.: 13/630,799

(22) Filed: Sep. 28, 2012

(51) Int. Cl. G06F 17/50; G06F 17/18; G06G 7/48

(52) U.S. Cl. CPC G06F 17/5009; G06F 17/18

(57) ABSTRACT

A system and method for creating modeling and simulation operational planning tools of human crowd behavior, in order to provide commanders with the capability to forecast crowd response to military or other control force tactics, techniques, and procedures. The modeling system or method use empirical data by collecting data on human crowd behavior under controlled laboratory conditions. It builds a mathematical model by using the collected data to reflect statistical relationships among the input and output data. It further statistically compares between the recorded empirical data and the data predicted by the present system or method. It creates simulation process steps based on the empirical mathematical model.

### GOVERNMENTAL INTEREST

The invention described herein may be manufactured and used by, or for the Government of the United States for governmental purposes without the payment of any royalties thereon.

### FIELD OF THE INVENTION

The present invention relates to the field of computing devices, and more particularly relates to computing devices for analyzing and modeling human crowd behavior, in order to satisfy the need for information to support the commanders' decisions relevant to the management of crowds in military or civilian scenarios.

### BACKGROUND OF THE INVENTION

Commanders on the field need a tool to help them accurately predict the range of crowd responses to their tactics or actions. The need for information to support the commanders' decisions is important to manage the crowds in military or other scenarios. More specifically, in certain conflicts, commanders have looked to the fools of modeling and simulation to assist in forecasting the outcomes for different tactical options.

A conventional simulation approach has been to select theories or rule sets of human behavior thought to be relevant to the specific scenario, and to turn the relationship among variables specified in the theory or rule sets into code. Reference is made for example, to R. B. Loftin, et al., “Modeling Crowd Behavior for Military Simulation Applications,” K. R. W. B. Rouse, Organizational Simulation, pp. 471-536 (2005); F. D. McKenzie, et al., “Integrating Crowd-Behavior Modeling Into Military Simulation Using Game Technology,” Simulation & Gaming , 39, 10-38 (2008); L. J. Moya, et al., “Visualization And Rule Validation In Human-Behavior Representation,” Simulation & Gaming , 39, 101-117. (2008); and Y. Papelis, et al., Modeling Human Behavior, Chapter 9, J. A. Sokolowski and C. M. Banks (Eds), Modeling and Simulation Fundamentals: Theoretical Underpinnings and Practical Domains, John Wiley & Sons, Inc., Hoboken, N.J., USA (2010).

In the conventional simulation approach, there is a heavy reliance on social scientists as subject matter experts (SME) for development and validation of models and resulting simulations, as denoted in S. R. Goerger, “Validating Human Behavioral Models For Combat Simulations Using Techniques For The Evaluation Of Human Performance,” Proceedings of the 2003 Summer Computer Simulation Conference. Montreal, Quebec, Canada; and S. R. Goerger, et al., “A Validation Methodology For Human Behavior Representation Models.” West Point, N.Y.: United State Military Academy (2005). Therefore, the existing state of the art has been to use theoretical models and to use assumptions and estimates about needed numerical values to complete the model.

Several problems have been associated with this conventional approach. There are incomplete and conflicting theories of human behavior; therefore there are unresolved questions as to what theories are most accurate and which should be selected for coding. Even when a theory has been identified, there is difficulty in turning theories of human behavior into code. Some aspects of the human behavior are difficult to quantify in a manner that can be used in programming languages. Even when a theory has been successfully coded, the models are of limited use because they are architecture-specific. The specific code may not federate with other models with different architectures.

In the traditional approaches, there is a lack of objective methods for verification and validation of the models and simulations, except for a heavy reliance on qualitative subject matter experts' (SMEs) opinion. Moreover, while the resulting human behavior simulations may reproduce human behavior, they are not designed to capture from data the uncertainty in terms of the entire range of behavior, inherent variability from person to person, or probability of one behavior versus another. Typically, human behavior simulation has been used for entertainment and training, not prediction. Therefore, the conventional methods ways might not be suitable for creating software that needs to accurately reflect real world behaviors, variability, uncertainty, and range.

Therefore, a need arises for a method for modeling and simulating human crowd behavior, in order to satisfy the need for information to support the commanders' decisions relevant to the management of crowds in military or civilian scenarios. The need for such a modeling and simulation method has heretofore remained unsatisfied.

### SUMMARY OF THE INVENTION

The present invention addresses the concerns of the conventional modeling methods and presents a new system and method for creating modeling and simulation operational planning tools of human crowd behavior, in order to provide commanders with the capability to forecast crowd response to military or other control force tactics, techniques, and procedures.

An important tool for operations research and systems analysts for current theaters of irregular warfare is the modeling and simulation of crowd behavior, especially in response to a military crowd management team. However, there are several criticisms of current state of the art in modeling of human behaviors, including lack of data, incomplete and conflicting theories, difficulty in coding, architecture constraints, reliance on subject matter experts, and lack of objective methods for verification and validation against real world data.

An object of the present invention is to present a novel method for modeling laboratory based on empirical data, a general approach to stochastic modeling and simulation of human behavior, and quantitative methods of verification and validation of those models and simulation of human behavior. This method includes critical laboratory experimentation, mathematical procedures, methods to capture human behavioral data for input and analysis in computer modeling and simulation.

The present method also includes iterative creation of the mathematical models that capture relationships among variables and iterative creation of stochastic computational models that calculate predictions based on the mathematical model. The method also includes verification and validation procedures for comparison of simulation outputs against real human behaviors.

The present method produces computer models and computational processes that can be used in computer tools for forecasting crowd behavior in military scenarios. That is, the present method produces equations to be used to calculate predictions about crowd behavior.

The resulting forecasting tool for commanders utilizes these mathematical and computational models as a basis for forecasting crowd behavior and associated probabilities.

To this end, the present invention enables the generation of stochastic human behavioral models and simulations (1) that are based on empirical data on actual human behavior, (2) that are relatively independent of any specific theoretical orientation or architecture, (3) that yield interim and final outputs that can be validated against actual human behavior (4) that are less dependent on subjective opinion for modeling building and validation.

Instead of relying on the conventional crowd theories or rule sets of human behavior developed by social scientists for the creation of behavioral models, the present invention uses experimental methods and objective measurements under controlled conditions, such as motion capture of subjects either in a laboratory environment or from surveillance footage, to derive coefficients for equations which quantitatively model a crowds behavior, which are can be validated at more than one point in the present process.

The resulting forecasting tool is more accurate at forecasting crowd human behavior because its models are based on quantitative metrics of actual behavior. These quantitative models are used in simulations for decisional support. To run the simulation the user specifies characteristics of the crowd versus control force scenario in question which are translated into numerical values to be inputted into the models for predictive calculations.

The processes embodied in the present invention can be built, for example, from the Lewian Field Theory, which proposes that human behavior can be explained as attractions and repulsions toward and away from real (physical) and irreal (psychological) goals (Lewin, K., “A Dynamic Theory of Personality. McGraw-Hill, 1935, pp. 286). This type of approach to crowd behavior has led to the development of a model that uses mathematical and statistical methods to identify predictor attributes of a crowd versus control force situation that influence the crowd behaviors of interest to commanders.

The present method is capable of modeling a crowd's path deviation response to different weapon, device, or control force emplacements as the crowd moves towards an objective of positive valence, which might aid commanders in choosing and positioning those weapons. Commanders need tools for planning, decision support, and analysis related to crowd management.

To this end, the present method uses probabilistic crowd modeling and simulation tools for forecasting human behavior. Current methods for modeling and simulation of crowd behavior are primarily made for training or entertainment and are not suitable for forecasting or analysis of real crowd behavior because they lack empirical data.

In one embodiment, the present invention uses controlled experimentation and behavioral science methods for:

(1) the design of controlled experiments for quantitative data on crowd behavior, and to capture the crowds' response to non-lethal technologies and surrogates;

(2) the design of tactically relevant experimentation relating relevant METT-TC (mission, enemy, terrain and weather, troops and support available, time available, civil considerations) variables to tactically relevant crowd behavior;

(3) collecting and analyzing metrics of crowd behavior;

(4) deriving mathematical algorithms relating predictor METT-TC variables to crowd behavior of interest;

(5) deriving mathematical indices of variability/probability;

(6) deriving statistical evaluation of model fit; and

(7) using hypothesis testing methods for forecasting crowd behavior.

More specifically, the present method develops models based almost entirely on empirical data of human behavior. Therefore, these models can be thought of as resulting in higher fidelity, compared with those built on theory, rules sets, or conjecture. Building on human behavioral data allows the model to capture the behaviors, range, variability, probability, and uncertainty of the dynamic nature of human behaviors.

Starting with the collection of data on human behavior allows the configuration of a test to gather data on the information relevant to building the models and simulation specifically to answer the commanders' and decision makers' questions. The information may be used directly, in extrapolation or interpolation, or to understand mathematical relationships among the variables tested.

The advantages of the present method are that these higher fidelity models result in more accurate forecasting, and therefore more trustworthy decision support to the commanders compared with conventional modeling methods. The present invention increases the availability of data on human behavior, facilitates the development of architecture-free, reusable, composeable, interoperable human behavioral models and simulation, and provides objective verification and validation metrics.

It also provides decision support to commanders, specifically with quantitative information based on human behavioral data gathered under controlled conditions. Higher fidelity models of crowd behavior yield more accurate simulation tools for decision support.

Additional aspects of the present invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram that illustrates a high level architecture of a modeling and simulation system according to a preferred embodiment of the present invention;

FIG. 2 comprises FIGS. 2A, 2B, and is a block diagram that outlines the organizational flow of the process within the system architecture of FIG. 1;

FIG. 3 is a grid illustrating the motion capture crowd members locomoting toward a protected area behind a control force, in a laboratory setting;

FIG. 4 is a flow chart that illustrates the sub-processes of a load data step of the modeling and simulation method of the present invention;

FIG. 5 is a flow chart that illustrates the sub-processes of a modeling step of the modeling and simulation method of the present invention;

FIG. 6 is a flow chart that illustrates the sub-processes of a simulate/run model step of the modeling and simulation method of the present invention;

FIG. 7 is block diagram that illustrates the constituent modules of a simulation tool during user operations, using the modeling and simulation method of the present invention;

FIG. 8 is a flow chart that outlines the organization flow of the modules of the simulation tool of FIG. 7;

FIG. 9 is a flow chart of a run simulation sub-process that forms part of the organization flow of FIG. 8;

FIG. 10 is a block diagram of a calculation configuration sub-process that forms part of the run simulation sub-process of FIG. 9;

FIG. 11 comprises FIGS. 11A, 11B, 11C, and is a block diagram of a calculation configuration sub-process that forms part of the run simulation sub-process of FIG. 9; and

FIG. 12 is a block diagram of the calculation configuration sub-processes that form part of the run simulation sub-process of FIG. 9.

### DETAILED DESCRIPTION OF PREFERRED EMBODIMENTS

The present invention provides a novel and non-obvious method and system (collectively referred to herein as “the method,” “the system,” “the tool,” or “the computer program product”) for analyzing and modeling simulation operational planning tools of human crowd behavior, in order to provide commanders with the capability to predict crowd response to military or other control force tactics, techniques, and procedures.

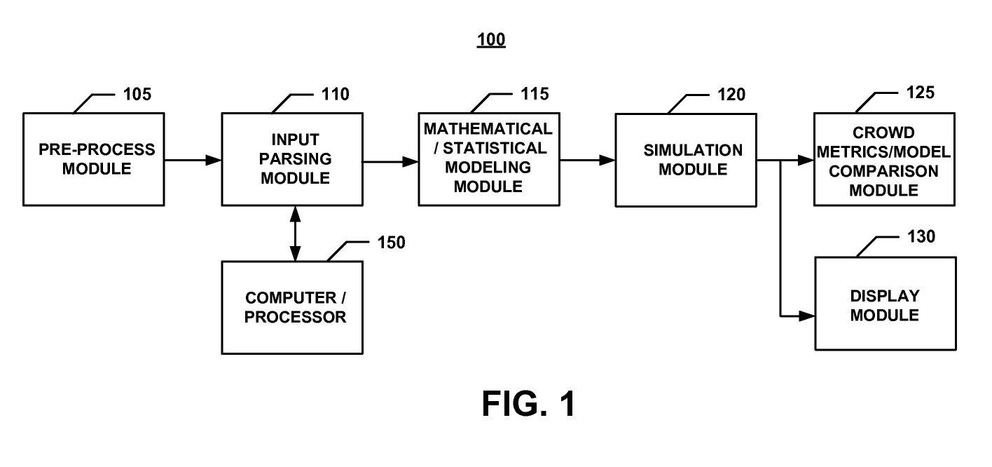

FIG. 1 illustrates a high level architecture of the modeling and simulation system 100 according to a preferred embodiment of the present invention. The system 100 generally includes a pre-process module 105, a model input parsing module 110, a mathematical/statistical modeling module 115, a simulation module 120, a crowd metrics and model comparison module 125, a display module 130, and a computer processor module 150.

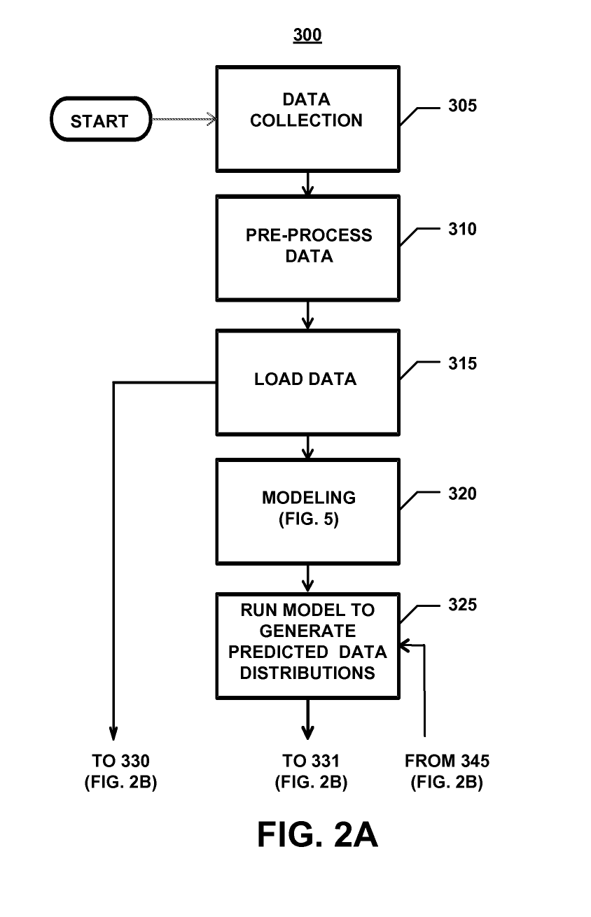

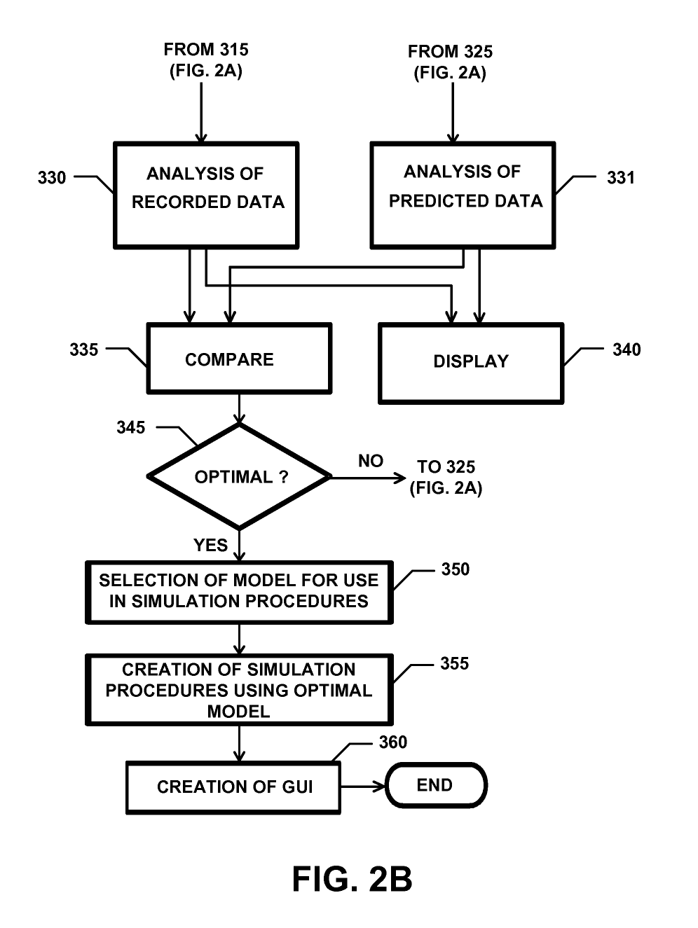

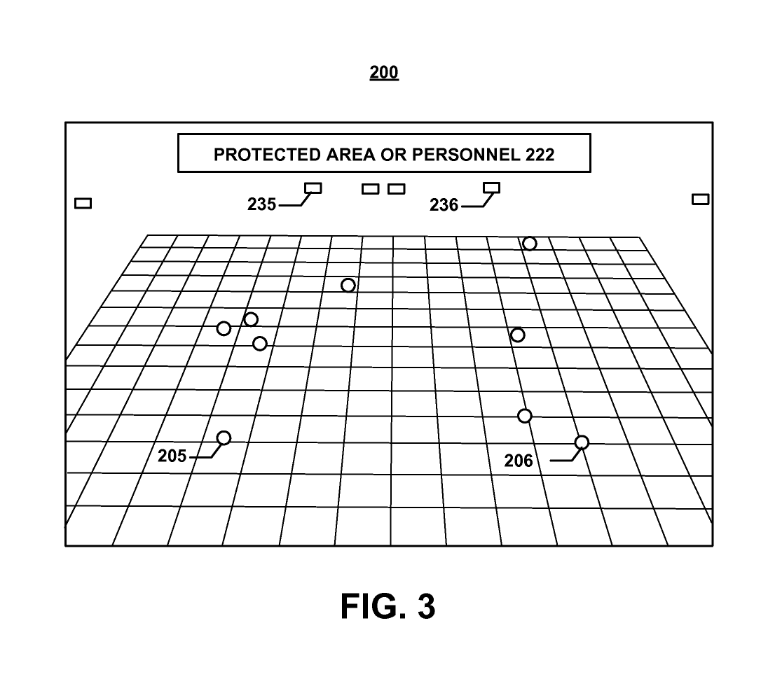

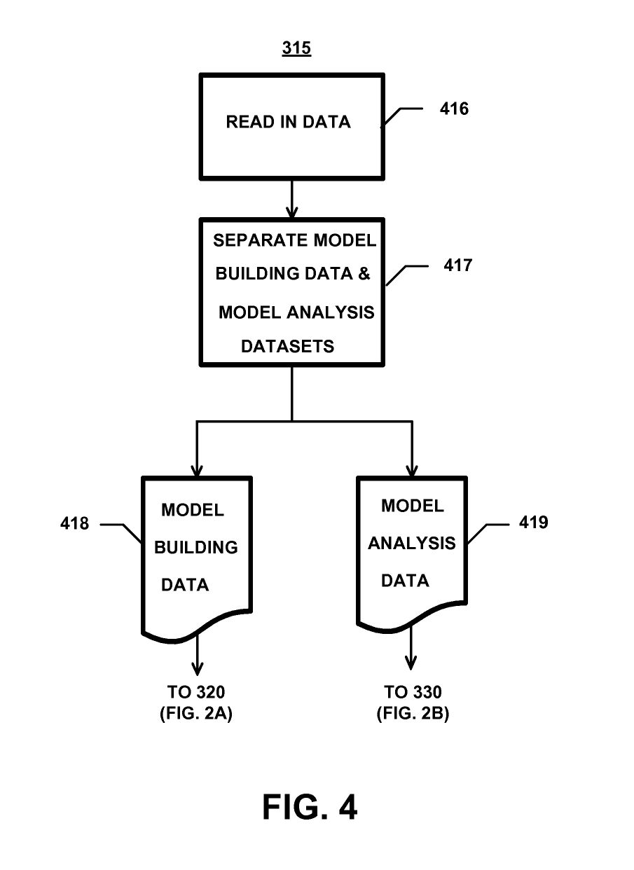

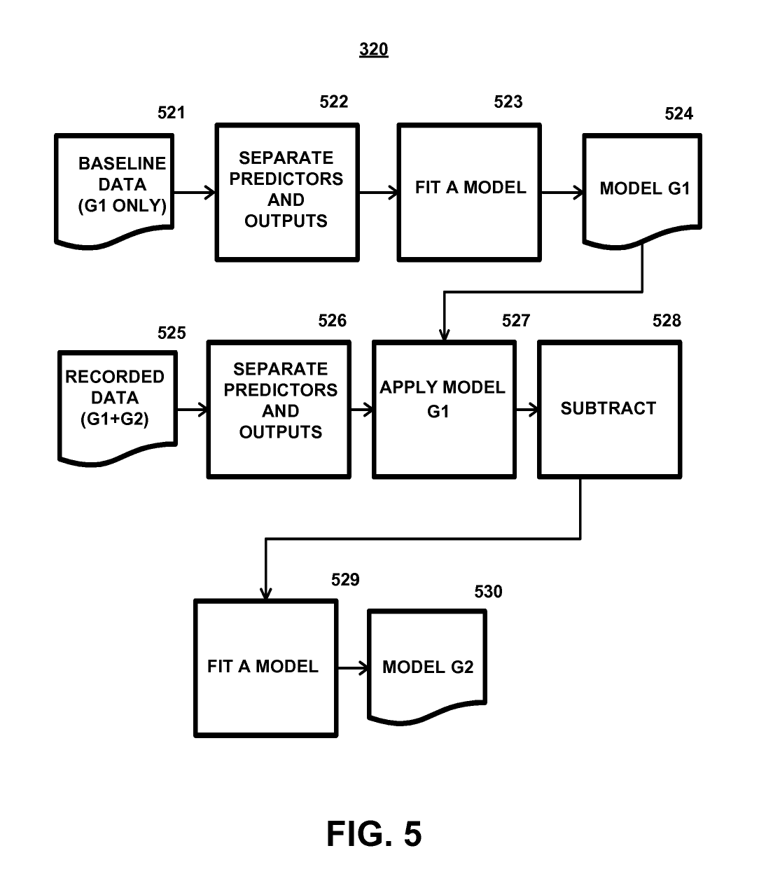

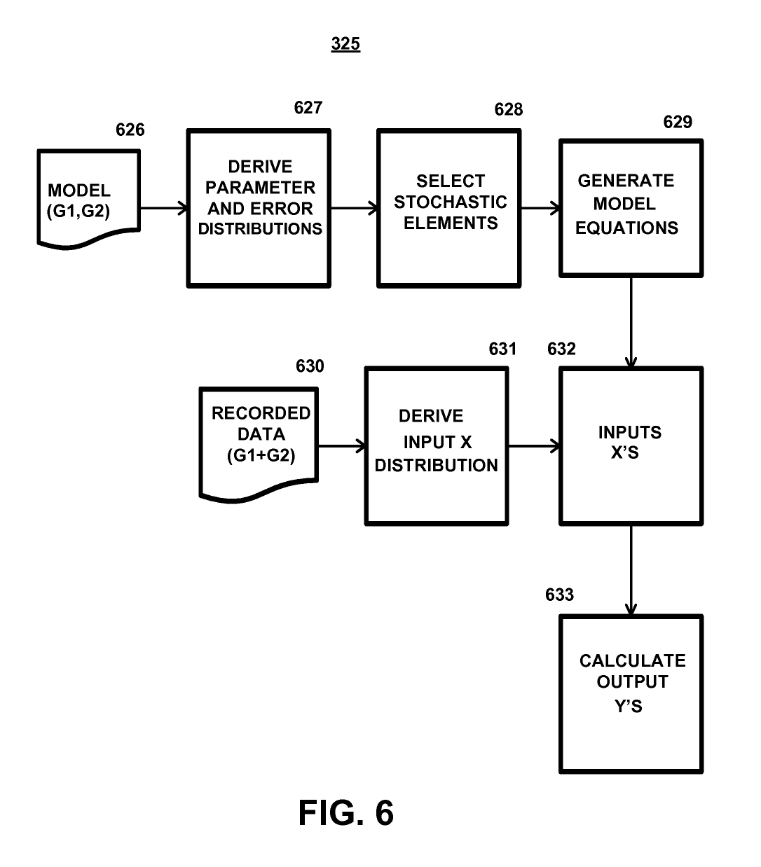

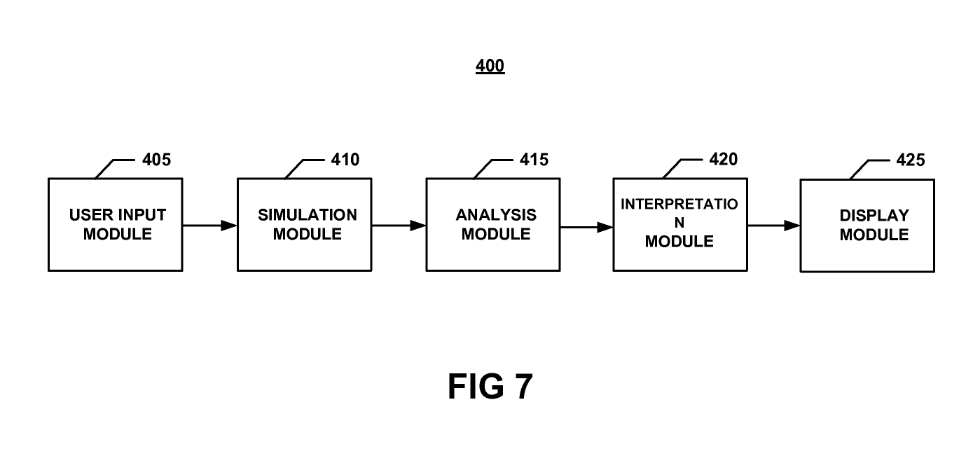

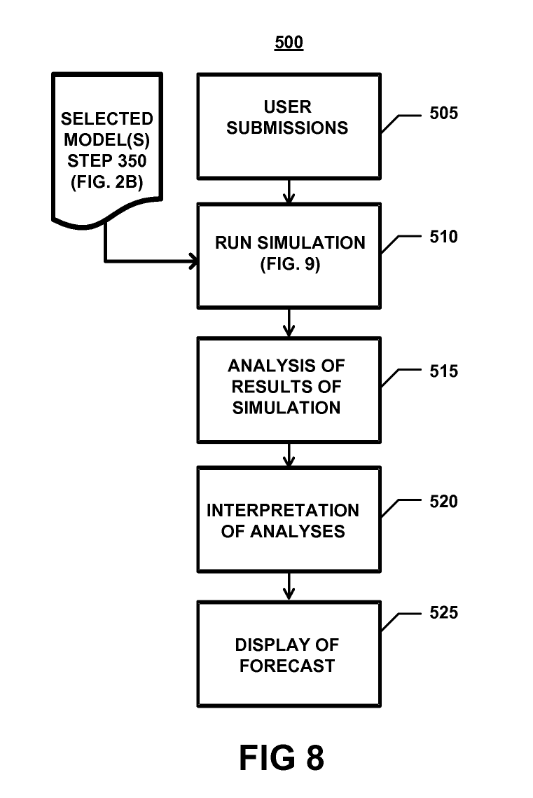

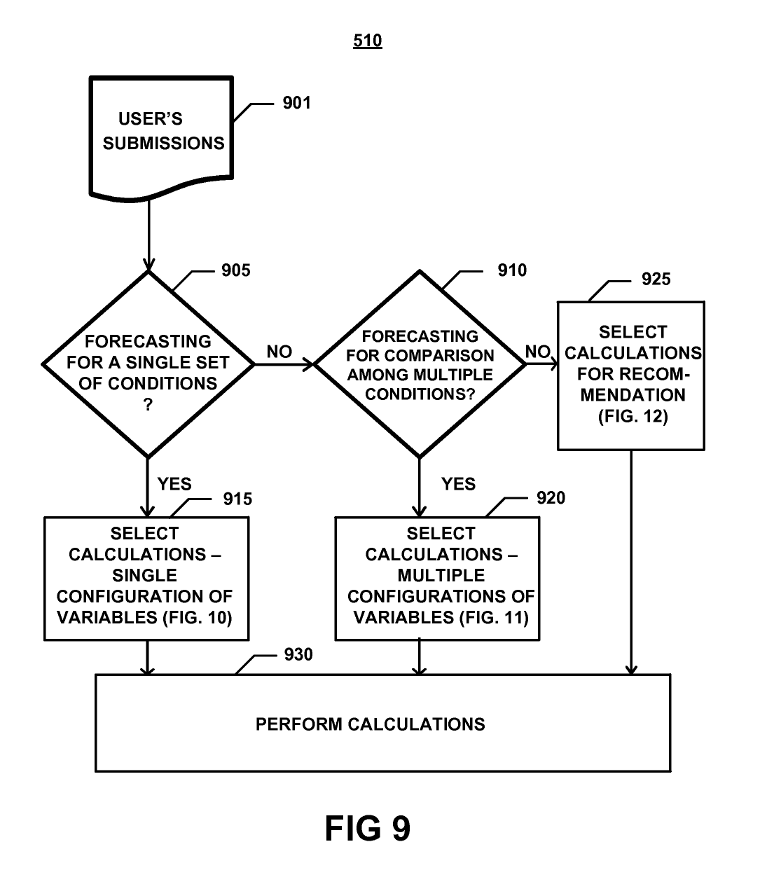

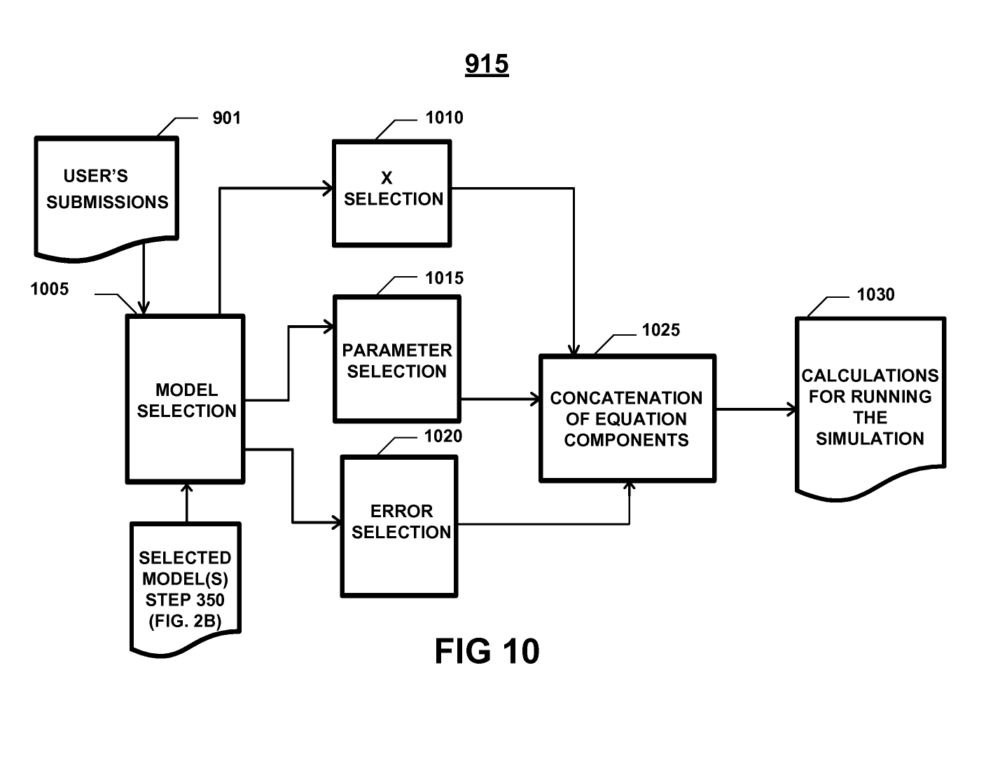

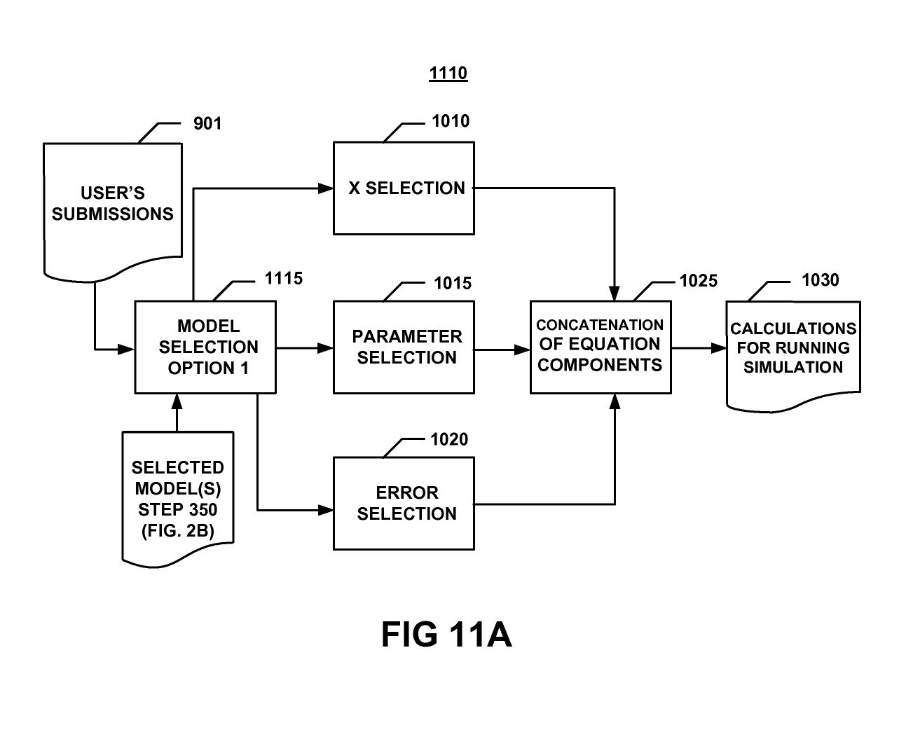

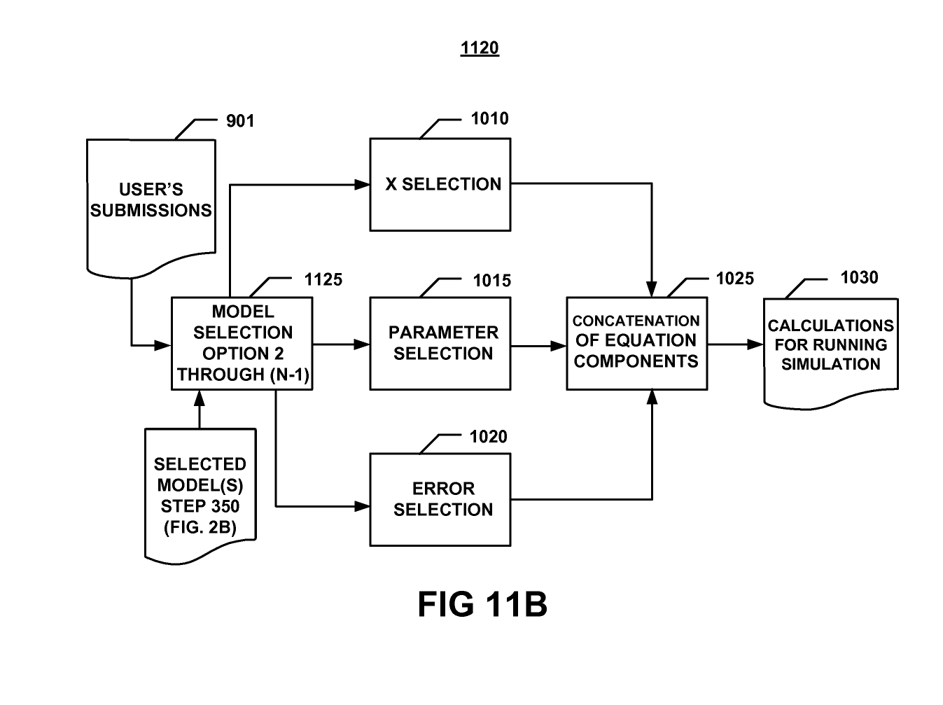

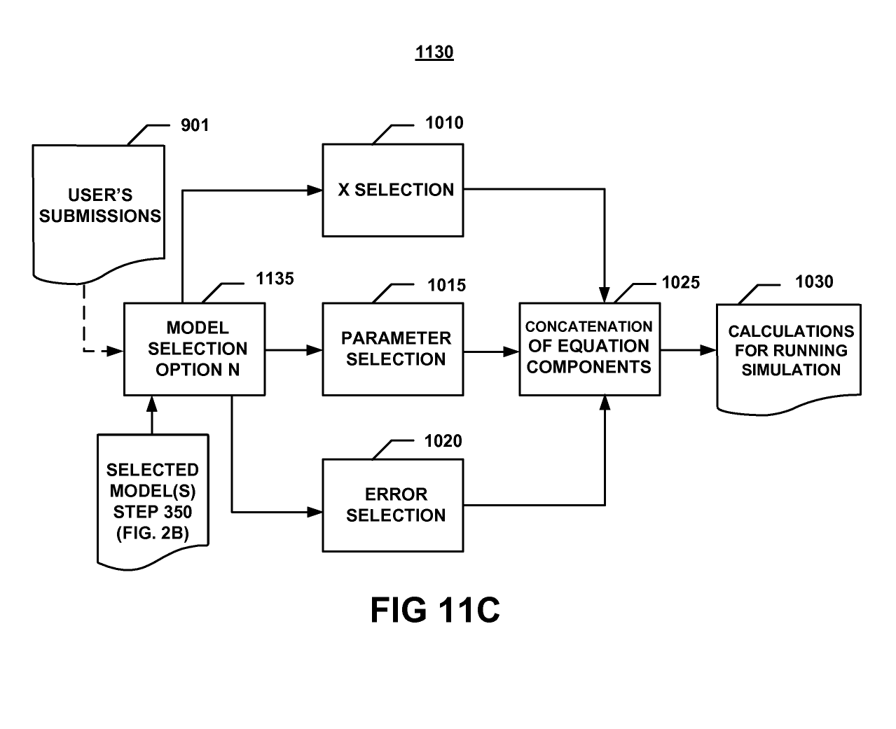

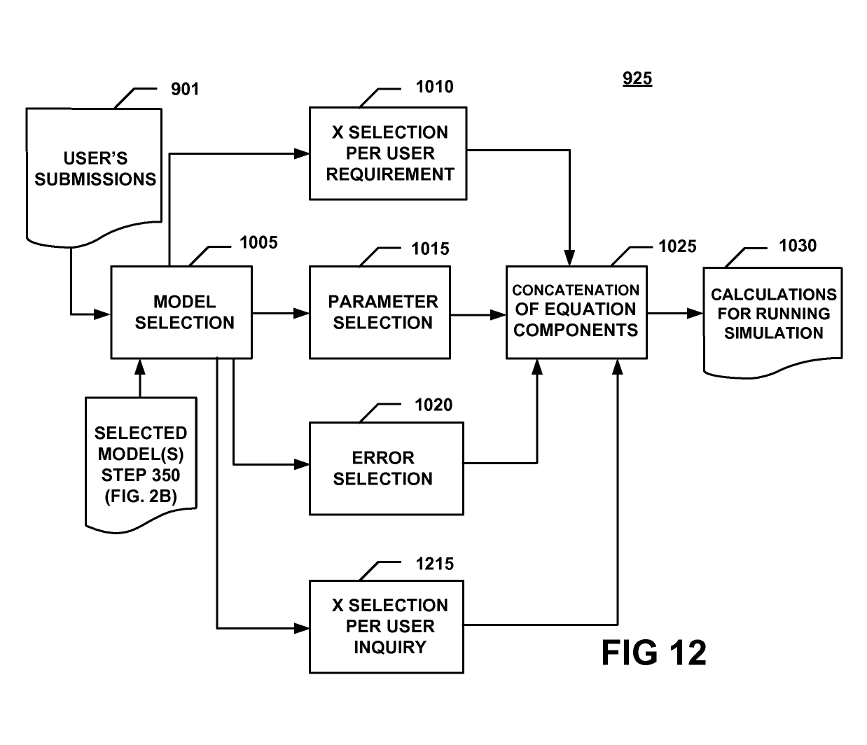

With reference to FIG. 2 it illustrates the simulation method (or process) 300 of the present invention, and reflects the architecture of the modeling and simulation system 100 of FIG. 1.

For the purpose of modeling, there is a need to have a uniform format for model input where data are organized in a manner so that the dependent and independent variables are easily distinguished for each condition. In this exemplary embodiment, the pre-process module 105 was developed to restructure the location data file into a uniform file format, where each row within a two-dimensional matrix represents data for one subject for a time step, and is followed by additional data for other subjects for that same time step, and is further followed in the same order for additional time steps. This format will be used in all the modules of the system 100. For raw data formats other than .csv, a pre-processor will need to be created to restructure the data into this predetermined uniform data format.

Considering now each of these modules in detail, with further reference to process 300 of FIG. 2, the pre-process module 105 (FIG. 1) is representative of step 310 which processes the collected raw motion capture and other data, collected in step 305 of FIG. 2A, into a form that can be used in subsequent processes (steps 315 and 320), to derive the mathematical model. The pre-process module 105 receives location data, for example, comma separated value (csv) format, storing all subject data for each trial in one file, where each subject's data are appended to the end of the preceding subject.

The Pre-Process Module 105

The pre-process module 105 accepts the location data as an input and creates a single file for each test condition (e.g., baseline, weapon 1, weapon 2, etc.). In one embodiment, the script file for pre-processing the data has six main sections: set constants, run index file selection, create condition list, processing of each trial, error checking, and saving data based on trial conditions. Setting constants involves setting test bed and trial parameters that are constant across all experimental trials. These parameters are: starting line location (place on test bed where all trials begin), sampling rate from pre-process module 105 at which data was collected, sample column designation, trial duration, X, Y, and Z location data columns.

The run index file is a required input file that lists the files to be read in. This section asks the user to select the location on the drive where the run index file is located and then opens, reads, and stores the file contents as a data table, then closes the file. The data table is formatted where column 1 contains the experimental run coupled with the trial number, column 2 contains the date of the run, column 3 contains the trial number, and column 4 contains the test condition.

The ‘create condition list’ section creates blank data files for each condition with column labels that are structured in the uniform data format. The blank data files are saved in the same folder as the run index file. The processing section loops through all the location data files listed in the run index file and extracts necessary data to fill the blank data files created in the condition list section.

During the looping process the following steps are completed:

The trial information is extracted from the run index file.

A file path is created for the condition being processed.

The subject number is used to find the start of each subject's data for each trial.

Once the index is found for each subject's hat number, the data is read and stored in a data file.

This data file is then used to create a matrix that sorts and reformats the data into columns and rows. The subject ID is formatted to incorporate the run date, subject number, and trial number. Similarly, the run ID is formatted to incorporate run date and trial number. The sample number is converted to time in seconds. Locations are also converted from millimeter to meters.

The change in position is then calculated at each time increment and used to calculate the velocity of the subject.

The data-set is then sorted to find rows of data that correspond to times within the duration of the trial.

The sorted matrix with each subject's data is then checked to verify that none of the data reflects times when motion tracking was dropped.

Data matrices are then appended to appropriate files based on trial condition.

Once data is sorted into appropriate files, then an error check is done to remove dropped tracking and phantom data points that allude that subjects are traveling at unlikely speeds. The newly formatted data are then appended to the appropriate files based on test conditions where each condition file is considered a standard input data file (SIDF).

The Model Input Parsing Module 110

The model input parsing module 110 parses the processed data from the previous step into predictors and predicted variables used to derive mathematical/statistical models in the subsequent mathematical/statistical modeling module 115, as further illustrated by step 315 of FIG. 2A and FIG. 4. The model input parsing module 110 is created as an independent function that opens the SIDF file, parses it into two data subsets (1) Model Building Data (step 418 in FIG. 4) and (2) Model Analysis Data (step 419 in FIG. 4). Each data set is further parsed into three elements, header vector, predictor matrix, and output matrix. The model building data subset is used for the purposes of building the model in the mathematical/statistical modeling module 115. The model analysis data subset is used for the purpose of validating the model in the crowd metrics and model comparison module 125.

The header vector is derived from the first row of the SIDF and includes the headers of all the columns that are included in the predictor matrix. The output matrix (n×2) includes the (Vx) and (Vy) velocity vector values, where “n” represents the number of data points. The predictor matrix (n×p) comprises all the data included in the SIDF, excluding the output matrix and the header vector, where p represents an arbitrary number of predictor variables.

The predictor matrix is formatted such that columns 1 through 5 are designated to subject identification number, time (seconds elapsed), X location relative to Control Force (CF) Y location relative to CF, and run identification number respectively. It should be understood that any number of column designation may be used, and the data collection module 110 may be capable of finding the primary columns based on designated column names. This will eliminate the need for hard coding column index values, and will allow for a more flexible SIDF file.

During each trial, subjects generally cross a start line, approach a linear target, turn around, and return to the start line. The goal of this effort is to model the approach portion of the trial. A function was created to parse the two primary sections of the trial: approach, and retreat. This function first iterates through each subject and stores the subject's data in a table, then finds the closest approach coordinate and log the time that this occurs. The data before the peak are stored as the approach and the data afterwards are stored as the return.

The Mathematical/Statistical Modeling Module 115

The mathematical/statistical modeling module 115 accepts as input, the data formatted by the data collection module 110, and creates the mathematical equations reflecting the relationship between predictor/input and predicted/output variables, as further illustrated by step 320 of FIG. 2A.

There are two testing paradigms in the crowd management experiment: a condition that only uses the target (baseline) with no protection by non-lethal devices, and another where the target is protected by either a control force member and/or a non-lethal device. To accurately model the behavior of the test subjects, their behavior from the single influence of the target alone (baseline) is used to generate a model of the attractive force generated by the target. This model is used to subtract the force created by the target out from the data collected when both the target and a non-lethal device are present. The result of the subtraction provides values for the influence of the non-lethal device alone. The mathematical/statistical modeling module 115 is further depicted in more detail in FIG. 5.

The mathematical/statistical modeling module 115 estimates for Beta0, which depends on which style function we choose to use, according to normal mathematics methods. For example if the Gompertz function were used, the three estimates equates to: (a) the upper asymptote (i.e., max); (b) X shift for the center of the function (i.e., median); and (c) the growth rate (i.e., highest slope). Other examples include using all zeros or all ones as the starting estimates can alternatively be used.

The mathematical/statistical modeling module 115 does the regression of velocity vectors in, for example, both X and Y axes against the predictors, generating model coefficients for change in location in the X and Y coordinates, along with confidence intervals for input values. The model, the predictors, and responses are then processed to determine the model errors that are then fit to the Weibull distribution.

The mathematical/statistical modeling module 115 incorporates the effects of the CF differed from the above description in that it also converts the coordinates from Cartesian to polar coordinates with the origin at the CF location. The polar coordinates are used to fit the model instead of the Cartesian coordinates.

The mathematical/statistical modeling module 115 includes a Linker function that takes in an existing data set from crowd behavior experimentation and extracts the elements needed to run a simulation that replicates the same initial conditions. It allows for the simulation to start with the same starting location as the real data which allows direct comparisons between simulation and laboratory data. The Linker function is developed to satisfy this need by searching the SIDF for the lowest time value for each subject and creating a s×p matrix called ‘Start’, where ‘s’ is the number of subjects. In addition, the Linker function computes the average time between samples for each subject (del_t) and the logs the highest time value in the input (t_end).

In this exemplary embodiment, the Linker function calculates del_t as the average time in seconds between all data points. The limitation in using this function is that if there are subjects that had some data loss, this may not truly represent the time step for everyone. To mitigate this effect, two steps will be implemented. First, explore the settings of the motion capture system to determine if the sampling rate that the data is being captured can be logged with each data point and made available in the SIDF. Second, improve the function of the pre-process module 105 to fill in NaNs (Not a Number—missing data designation) wherever data loss occurs. These improvements will allow a more accurate calculation of del_t and lead to equal structuring of the data, so that locomotive behavior that occurs in the raw data at a specific time will be attributed to the correct contributing factors that occur at that time.

The Simulation Module 120

Similarly to the mathematical/statistical modeling module 115 illustrated by step 320 of FIG. 2A and FIG. 5, the simulation module 120 uses functions to achieve the modeling of the baseline condition and the CF condition, as further illustrated by step 325 of FIG. 2A and FIG. 6. The simulation module 120 is built to execute a time stepped simulation of each subject's behavior based on the provided model and start conditions identified by the Linker function. At each time step the new locations are calculated and time advanced. The current state is updated and appended to the result. The inputs to the function are model, start, t_end, and del_t.

In this exemplary embodiment, the model input is a 2×p matrix of coefficients, with the first two columns designated to the velocity component in X and Y direction respectively. The start input is a s×p matrix of the starting conditions for each subject that will be modeled. The Lend is the desired time that the simulation will run for and the del_t is the time between iterations. The function determines the number of iterations from t_end and del_t. Then, the function steps through each iteration calculating the change that in velocity in X and Y directions, the change in distance, the change in position for each subt. The output of the function is titled sim_result, a n×p matrix structured in the same manner as the predictor matrix. A future desired feature is to add the capability to calculate derivative variables, relative to position, in real-time (i.e., distance to target, distance to control force). This feature can be beneficial if the model is influenced by these variables.

The simulation module 120 is designed to incorporate CF effects, and it transforms the coordinates of the baseline model to fit that of the CF model, where the CF location is the origin for polar coordinates.

An alternative embodiment uses Bayesian statistical methods to generate mathematical models. Bayesian statistics may be used to measure probability or uncertainty associated with the occurrence of a particular event that reflects the current state of knowledge or available data. The prior information (the recorded test data) was incorporated into likelihood functions. The resulting output is a posterior distribution of coefficient values. A Bayesian general linear model (function bayesglm) may be used in R Statistical Programming Language to get a summary of the output. This is considered a shortcut method because if does not create empirical distributions from the posterior data. The Markov Chain Monte Carlo simulation method creates the empirical distributions. This is done using the MCMCregress function in R. This method provides coefficient estimates and credible intervals for coefficients. In this embodiment, running the simulation is the execution of the model using these coefficient estimates.

With reference to step 340 of FIG. 2B, the display module 130 is a function that displays the time plots of the simulated and observed data, allowing for a side by side view of movement patterns. The inputs to this function include simulated data and the observed data. The function creates two subplots of the observed and simulated movement pattern for each subject. The function also scales the plots appropriately so that both plots have the same axis limits.

The Crowd Metrics/Model Comparison Module 125

The crowd metrics/model comparison module 125 includes several sub-modules or functions, that are merged into a single block for ease of illustration, as further illustrated by steps 330, 331, and 335 of FIG. 2B. The crowd metrics/model comparison module 125 includes a data parser function that is built as an independent function for splitting the input file (predictor matrix or sim_result) into a run_data_cell matrix that is sorted by time, run ID, and subject ID. This function arranges the data in such a way that crowd metric calculations can be done on each time step, for a particular trial/run, including only the subjects that were a part of that run. This is achieved by first sorting the input file in time order, then parsing the input file into a cell matrix where each cell represents a trial. Then, each cell is parsed into subject ID. This allows for calculation of crowd metrics at each time step (such as leading edge, trailing edge, centroid, which can then be averaged to determine an overall metric for the crowd. Reference is made to G. Cooke, et al., “Topology And Individual Location Of Crowds As A Measures Of Effectiveness For Non-Lethal Weapons,” Proceedings of the 27th Army Science Conference, 29 Nov.-2 Dec. 2010, which is incorporated herein in its entirety.

With further reference to FIG. 3, it illustrates a grid 200 that reflects the motion capture crowd members (e.g., 205, 206) locomoting toward a protected area 222 behind a control force (E.G., 235, 236), in a laboratory setting. In this respect, the crowd metrics/model comparison module 125 also includes a crowd metric sub-module which is built as an independent function that calculates the leading edge (LE), trailing edge (TE), centroid, geometric center, and dispersion for the crowd (Cooke et al., above). These measures are considered aggregate metrics of crowd behavior as a whole, rather than individual paths taken by each subject. The input to the function is either the observed data or simulated values that were formatted in the data parser function. This function returns the crowd measures based on a set of input data. The input matrix for example includes the radial location from the target goal; with the linear target this equates to the y-axis location. The y_data contains rows for each time step and each column corresponds to individual subjects. The function calculates the LE by finding the maximum y_data point for each run. The TE is calculated similarly but with the minimum y_data point. The centroid is calculated by taking the mean of the y_data. The geometric center is calculated by taking the average of the leading and trailing edge. Dispersion is calculated by evaluating the average displacement in the X and Y direction. The function then plots the LE and centroid for a time step for visual inspection. Other crowd aggregate behavioral measures are calculated at this step, such as number of rocks thrown, time in the line of fire, or social network analysis metrics.

The crowd metrics/model comparison module 125 further includes a model comparison sub-module that compares the output of the simulation with the original human data collected in the laboratory, as further illustrated by step 335 of FIG. 2B. Ideally, the human data used in the comparison is a set collected under the same conditions as the data used for modeling. For example, an available data set can be split into subsets of modeling building data and model analysis data for comparison with simulation output. This process is akin to establishing “split-half reliability” in behavioral science. A subset of data for this validation purpose is created in the input parsing module 110, as further illustrated by step 315 of FIG. 2A and FIG. 4.

The model comparison sub-module is built as an independent function that receives crowd level metrics from laboratory testing data and simulation data for statistical comparison, as depicted by step 335 of FIG. 2B. This module uses two-sample Kolmogorov-Smirnov (K-S) goodness of fit (GOF) test (kstest2) to determine goodness of fit for crowd metrics. Reference is made to Mathworks, Inc., “Nonlinear Regression” (2011), Nonlinear Regression (nlinfit), Statistical Toolbox, MATLAB, which is incorporated herein by reference.

This function accepts two sets of data, significance level (alpha), and type of alternative hypothesis test. The kstest2 function compares the cumulative distribution functions (cdf) of the observed and simulation data to determine if the simulation follows the same distribution as the observed data (hypothesis acceptance), the asymptotic p-value, and k-statistic. The null hypothesis is that both observed and simulation data are from the same continuous distribution. If the null hypothesis (h) is accepted, h value is 0, but 1 if rejected. The k-statistic is the greatest distance between the cdf plots of the observed and simulation. For the model comparison module 5% significance level (α) was used and the default of unequal alternative hypothesis test.

Other statistical methods, such as Bayesian, with approaches to testing and accepting a null hypothesis can be used (Reference is made to John K. Krushchke, “Doing Bayesian Data Analysis” 2011, Elsevier, Inc. Burlington Mass.).

The Data Collection Step 305

The modeling and simulation method 300 (FIG. 2) starts at step 305 with the collection of data. Data are used to construct the mathematical model underlying the prediction tool. Data collection may be accomplished by using existing data collection methods, such as archived data, such as data found in after action reports, historical accounts, survey, or interview data or video recordings of crowd and military action events, such as found in law enforcement or open sources on the internet. While these collected data can be used, they are typically of poor quality because the collection methods are not structured to collect the specific information that is needed to design a model of human crowd behavior.

Video recordings, interviews, typically focus on exciting and noteworthy events as deemed by the camera person, the interviewer, or the reporter and do not accurately portray all the factors that may determine the outcome of a crowd control force encounter. The relevant data that can be extracted from these conventional methods are therefore indirect and may even be misleading.

The preferred method according to the present invention is to collect data on crowds and crowd management forces under controlled laboratory conditions. This method is an improvement over the conventional data collection methods because experiments can be directly designed to more precisely answer the questions that commanders ask in crowd management situations.

Standard behavioral science methods can be used to develop a detailed study of crowd-crowd management team interactions. For example, if the requirements are that the commanders need a modeling and simulation (M&S) tool to predict what a highly motivated crowd will do differently from an unmotivated crowd, then data are gathered on crowds who are highly motivated and crowd who are unmotivated.

If the requirements are that the tool should be capable to predict crowd reaction to a laser compared with a noxious gas compared with a flash bang, then data are gathered on crowds in response to these stimuli or some simulation of those stimuli. If the tool needs to predict crowd responses to different tactics, techniques, or procedures of the control force (low versus high threat, verbal communications, etc.) data on crowd response to these situations are gathered in a controlled experiment setting.

As shown in FIG. 3, gathering data on crowds includes recording each person's location and locomotion. That is, research indicates that the commander's primary tasks in crowd control are to keep the crowd away from certain areas or personnel 222, or to induce the crowd to disperse or go away. Therefore, the critical crowd behavior that is recorded according to step 305 are x, y, z coordinate (or another coordinate system, such as polar) location throughout the testbed or grid 200.

Locomotion is then derived from the sequential recording of location throughout the scenario. Orientation, that is, where the person is facing, as an indication of intended locomotion is also recorded in the process. There are several methods that can be used in recording crowd member location, locomotion, and orientation. The traditional methods are to watch and analyze videotapes for location, locomotion, and orientation. There exist other methods such as Vicon® motion capture system, or the Ubisense® system. It should be understood that other GPS systems or similar tracking methods may be used. Alternatively, a pressure sensitive floor can be used to track the location and locomotion of the crowd.

Another improvement in using behavioral science techniques is that they can be used to infer or assess variables not readily observable by using the conventional methods of gathering data for modeling and simulation. For example, one requirement for the modeling and simulation tool is that it can predict how increasing fear tactics might affect an already fearful crowd. Behavioral science methods afford various metrics for fear, including psychophysiological methods (breathing and heart rate, blood pressure, skin temperature), behavioral assessments (avoidance, vocalizations, communications), and self-report questionnaires. These different metrics can be used to derive a “latent” variable of fear. Other critical unobservable behavioral variables can be used in the model to improve the accuracy of predictions.

It is important to note that standard behavioral science methods guide design of experiments and data collections when the exact situation cannot be replicated in the laboratory. That is, this method 300 does not require the exact characteristics of a commander's hypothetical situation be replicated in the laboratory. This method 300 does require, however, that the psychological and behavioral states of the laboratory crowds bear a close resemblance to the psychological and behavioral states of the operational crowds.

In the design of the experiment, the selection of independent variables is parallel to what the commanders would input into the modeling and simulation tool. Inputs are the conditions of the operation, the information about the crowd or crowd management force that is to be factored into the commander's decision. Inputs are also the possible control force methods, tactics, techniques, and procedures.

For example, if the modeling and simulation tool requires to forecast crowd response to non-lethal weapon stimuli, the weapon type is selected as an independent or manipulated variable in the design of the experiment. Another example is if the modeling and simulation tool requires to make predictions about response to weapons based on gender make-up of the crowd, then the percentage of women in the crowd is the independent variable manipulated in the experiment. Another example is that perhaps a commander needs to know how many forces to devote to the crowd, and then the supporting data will be collected under laboratory conditions that vary the number of control force that controls a crowd.

In the design of the experiment, the selection of dependent variables is parallel to what crowd behaviors commanders want to manage or control. Outputs of the tool are the predictions of crowd response given the inputs, which are the existing conditions and the possible crowd management tactics. For example, if the commander needs to know what tactics, techniques, or procedures will drive the crowd away then the dependent variable in the laboratory recorded is running away behavior in response to the control force. If the commander needs to know what is needed to stop a crowd from throwing rocks, then rock-throwing behavior (or some behavior akin to this) is recorded.

In general, the experiment is designed to parallel the operational conditions and operational choices that a commander must make using the final modeling and simulation tool. Ideally, the experiment is also configured to record and assess secondary variables that may have an impact on crowd response to control force tactics. Therefore, in the laboratory, data is also gathered on critical psychosocial variables, such as social networks in the crowd, communication patterns, presence or absence of leaders, martyrs, or instigators, etc. Social network analyses, standard observational and questionnaire data can be used to assess and record these type of psychosocial variables. Alternatively, these important psychological, psychosocial, and social variables can be manipulated within a parametric experimental design to derive models.

Raw data formats vary. Video recordings are used to record behaviors. Survey or other self-report data may be in paper format or computer data files. Physiological samples (e.g., blood, urine, saliva) may be collected as well as electrophysiological data (e.g., electrocardiographic, electroencephalographic, electrodermal). Analog or digital files may be data that track individual movements of people (e.g., x, y, z coordinate data on location, analog recordings of pressure sensors along a track). In this step 305, any format of data collection on human behaviors may be used.

The changes, additions, and improvements of the methods of data gathering are based on the data collection under controlled laboratory conditions, rather than derivation from secondary sources of information not intended to produce information for modeling and simulation for commander decisional support. This improved step increases the specificity and efficiency of data collection and therefore, the accuracy of the derived mathematical and computation models. The accuracy of the underlying models then has a direct impact of the accuracy of the predictions made for the commanders.

The Pre-Process Data Step 310

In the next step 310 of process 300, the raw data and samples that are collected at step 305, are processed. Data collected at step 305 are inputted into the 100 system at the pre-process module 105 and the input parsing module 110. The end product or output of this step 310 is the transformation of the collected raw materials and information into number values for the subsequent steps of the process 300. Standardized or other behavioral methods may be used for data processing and cleaning and apply to raw data whether collected according to conventional data collection method or under laboratory conditions.

There are other methods of data processing that are well accepted in behavioral science. In particular, the electronic signals recorded that spurious values, mistakes, errors, power spikes, and missing data periods are deleted, replaced, or noted. Data on the x, y, z coordinate locations are processed to yield higher order measures of velocity and orientation. Physiological samples are assayed for measures of the relevant hormone or substance. Questionnaires or surveys are scored to yield numerical indices of disposition. Video recordings are scored, and for example, the recordings may be examined for the number of times a certain behavior occurs. Behavioral observations that were handwritten during the experiment are also entered into data sheets.

The numerical values derived from the data processing activities are entered into a computer 150 (FIG. 1) or other device for further processing into higher order variables or for analysis in subsequent steps. For example, measures of catecholamines in the blood, heart rate response, questionnaire data, and observations of number of times a person ran away may be numerically combined to derive a “fear” index for that person. Numbers of interactions or social linkages among the members of the crowd are processed to yield an index of social properties of the crowd. The numerical values from this step 310 are used to derive mathematical equations that reflect the relationships among the independent variables, dependent variables, and other factors.

The Load Data Step 315

In the load data step 315, data are read in and separated according to standard split-half reliability testing methods. A subset of the original data is used for modeling building. FIG. 4 further illustrates the load data step 315 as comprising reading in data, step 416; separation of subsets of data, step 417; a build model data step 418; and an analyze model test data step 419 that will be used later in the analysis of recorded step 330 of FIG. 2B. The load data step 315 occurs within the system 100 at the input parsing module 110.

The Modeling Step 320

Data from process steps 315 (FIG. 2A) flow through the system 100 to the mathematical/statistical modeling module 115. The outputs of this step are mathematical models fit to the recorded data. These are the equations that yield predictions of behaviors as the computational model.

The objective of the development of the mathematical model step 320 is to identify or fit the mathematical function or functions that most accurately predict crowd behavior based on a set of independent variables/input variables. In step 320, the relationship of each variable to the other, especially input/independent to output/dependent variables is assessed. Ideally, the mathematical model also includes how that relationship among the variables may change through time.

The output from this step 320 is a mathematical model of the crowd-control force interaction through time. That is, the results of this step are the mathematical expressions of how to combine the measures of the input/independent variables to most accurately predict the output/dependent crowd behavior. Standard technical computing or behavioral science statistical processing programs, such as SPSS®, SAS®, Minitab®, Matlab®, Excel®, etc., can be used to assist in arriving at candidate mathematical models.

An example of the modeling step 320 is further illustrated in FIG. 5 that analyzes the relationship of the attractive and repulsive forces among the crowd members toward the goal target (G1) and away from the control force (G2). A system level discussion of the modeling step 320 has been described earlier. The analysis carried out at this step 320 uses the locomotion variables of the control force and that of the crowd members, in that locomotions toward the target indicate attractive forces toward the target and locomotions away from the control force indicate repulsive forces away from the control force. Within the field theoretical conceptual framework, locomotions toward or away from goal locations are indices of attractive or repulsive forces from those goal locations.

As shown in FIG. 5, the modeling step 320 is implemented by fitting a model predicting locomotion of the crowd members (Baseline Data G1, step 521) toward the target in the absence of the control force. After separation of predictors and output variables in step 522, a mathematical model is fitted to the data in step 523, resulting in a mathematical equation model in step 524. In a field theoretical framework, the locomotion is an index of the attractive force toward the target goal acting on the crowd members.

This mathematical modeling step 320 is used to generate predicted locomotion paths for crowd members, as shown in steps 525 to 527. The data recorded in the laboratory at step 525 is separated into predictor variables and output variables at step 526. At step 527 the predictor variables metrics are inputted into the model derived at step 524. For these predictions, the mathematical/statistical modeling module 115 is given as input the initial locations of crowd members at the start of the trials with the control force present guarding the target. The resulting paths are a prediction of locomotion would be if the control force were not present, and with the crowd members starting at those initial locations.

As illustrated by steps 330, 331, and 335 of FIG. 2B, the predicted paths are compared with the actual paths recorded when the control force is present guarding the target. With the control force present, the crowd members are under a combination of an attractive force toward the target goal and a repulsive force away from the target goal, step 525.

Subtracting the coordinates of the predicted paths from the coordinates of the observed paths yields an index of the repulsive force of the control force alone, step 528. The difference between the predicted data (step 331) and the observed data (step 330) is then modeled at step 529 to yield an equation capturing the repulsive effect of the control force at step 530.

Therefore two models are derived. One model is intended to predict behavior in the absence of interventions. The second model is intended to predict the effect of intervention.

These processes for creating mathematical models are applied to locomotion behavior, but other behaviors such as rock throwing or chanting behaviors may be modeled in this manner or others, as described below.

Other mathematical equation or set of equations may accurately reflect the relationships among variables. Data analytic methods that might be used are, for example, the typical behavioral science null hypothesis significance testing methods, parametric and non-parametric methods, generalized estimating equations, general linear models. These include, but are not limited to correlations, regression, structural equation modeling, canonical correlation and time series analyses. In addition, the newer Bayesian statistical methods can be used to identify observed relationships among variables. As an example, fitting to a regression equation may take the form of a linear, non-linear, or vector regression equation. However, the various forms of regression equation most typically are fitted to a set of variables that includes several independent/input variables.

In one embodiment regression analysis may determine that the prediction of a crowd halting approach to the protected area 222 (FIG. 3) may be a function of time of day, temperature, ratio of men in the crowd to number in control force, range or weapon, and levels of extrinsic motivation in the crowd. Moreover, the particular weighting factors for each of these variables can be calculated. In this example, the result is an equation that predicts whether or not a crowd halts approach based on several conditions.

Several candidate mathematical models or candidate sets of mathematical models may result depending on the data analytic strategy adopted, the variables selected for inclusion in the equation, interaction effects, or the methods of capturing effects of the passage of time. For example, one candidate mathematical model may want to include all possible variable in the equation; or for purposes of cutting down on computational processes, may only include variables that meet certain statistically significant levels, or only main effects, but not interaction among variables.

This step will identify or evaluate which of the candidate deterministic mathematical models makes predictions that are closest to reality as revealed in the laboratory. This step 320 compares predictions calculated from the equations with observations of actual human behavior in the laboratory. These are the equations that predict behavior that most resemble the observations of real behavior.

Standard behavioral science data analytics are used to evaluate the closeness of the equation to real behavior. For example, in the derivation of the regression equation, as part of the output of the data analysis program is a metric that reflects how well the regression equation that mathematically relates independent variables to dependent variables mirrors the relationships between the observed values of the real behaviors. Depending on the data analytic strategy used, indices of model fit include, but are not limited to the R² statistic, Chi Square statistic, the calculated mean squared error (MSE) or simply the unexplained variance reflected in the error term of the regression (ε).

These statistics reflect how well the observed data can be calculated by using the mathematical equations. The equation or sets of equations that best reflect the observed data, based on these model fit measures, is selected for further development into the computational model.

The entire mathematical model is a set of mathematical equations that describe empirically derived relationships among the elements and behaviors in the scenario (e.g., crowd interactions with control force; personality measures and martyr behaviors, leadership structures in the crowd and riot behavior, etc.). Because there are different approaches to deriving the entire mathematical model and the sets of mathematical equations, part of this modeling step 320 is down selection among candidate models. The modeling step 320 may go through several iterations before arriving at the optimal mathematical model to be used in the execution of the model calculations of the run model step 325.

The Run Model Step 325

The results from the modeling step 320 continue through the system 100 to the simulation module 120. The output of the run model step 325 is a set of predicted data stochastically generated from calculations using the model generated from the previous steps. As a result of the previous modeling step 320, the input into the run model step 325 is a mathematical equation or a set of mathematical equations that have been evaluated as best reflecting the relationships among the elements of the crowd-control force interaction as shown in step 626 of FIG. 6. For example, one should be able to use the resulting equations to predict whether a crowd will run away based on how many children are in the crowd or how frightened the people are. At this point, only one answer will result from a given set of x's, that is, the model is deterministic.

For example, if the crowd is described as being made up with 50% children and a frightened score of 73, the equation is set up to calculate one answer. That is, the model is deterministic. This is a limitation because the deterministic equations do not reflect the variability and range of possible human behaviors under the same condition.

Human behavior can be highly variable in that there are a number of possible behaviors that a crowd or a person can perform. A more accurate model of human behavior needs to also accurately reflect the degree of variability in and probabilities of the behavior. That is, the model should be stochastic, providing not only what the predicted behavior might be but how likely or the probabilities that certain behaviors will occur. What is missing to assist commanders is a measure of “how likely” this outcome will happen. In the preferred embodiment of the present system 100 and model 300, the stochastic component is also derived from empirical data.

The stochastic component is realized by creating distributions of the parameters, error, and input components of the model. These distributions are based on the empirical data; therefore, they reflect the range and variability of behavior found in real life. Computations are then executed by selecting parameters, errors, and input components randomly from these distributions.

Since, as mentioned earlier, human behavior can be highly variable, the computational model is built using the mathematical model with stochastic components, that is, with variations introduced so that different predicted values will result from calculation to calculation.

More specifically, ideally methods and processes are used to run a series of computer studies to derive probabilities of different human behavior outcomes under complex conditions. That is, the model is run iteratively, varying the equation at each run, so that a different equation is used and that different outputs are calculated each time. These distributions can be created using more than one method.

Bayesian methods may be used to derive a distribution of the parameters in the equation. As illustrated in FIG. 6, step 627 then creates a distribution of coefficients. Data from the laboratory are used to generate distributions of coefficients using COTS software that calculate Bayesian posterior distributions from data sets. Running the model at step 633 means randomly choosing coefficients from these distributions for the calculation of predicted data at steps 628 and 629.

Alternatively, using the distribution of inputs procedures, a distribution of coefficients can be derived from repeated derivation of equations using input data.

Also, at step 627, the run model step 325 creates the distribution of errors. Data from the laboratory are used to generate distributions of errors using COTS software such as Crystal Ball® or Matlab®. The errors are derived from steps associated with generating the mathematical models from the empirical data.

Outputs from statistical programs such as SPSS, SAS, Minitab®, and MatLab® also may be used at step 627. In these analyses, there is an option in from general or generalized linear model analyses to request calculations of coefficients, as well as the standard deviation for the distribution of coefficients. These parameters can be used to create a distribution of coefficients in programs such as Crystal Ball®.

These values, randomly drawn from these distributions, are used in calculations using the mathematical model. Based on the distributions or the parameters or other criteria, stochastic elements to be included in the computational model are selected at step 628.

Using either parameters drawn from the distributions of step 627 or other statistical means as described herein, a list of computational model equations is generated. These model equations will have as x's or inputs drawn as described in the following steps and as shown in steps 630 and 631.

For example, from the observed data scores of motivation of individuals, step 630 and 631, the method then calculates the mean motivation score across the total sample or across a subset of the sample (e.g., only men or women). In addition, in the run model step 325 the variability of the data can be calculated (e.g., standard error, standard deviation, range) and distributions of these central tendency and variability parameters are created at step 631. A commercial off the shelf (COT) software, such as Crystal Ball®, or by using Bayesian methods within R programming language or MatLab® or other technical computing software can be used to create an experimentally-derived distribution from which to randomly draw inputs for step 632.

At step 633, the run model step 325 runs the model that is, executes the computational model for a number of times. For validation purposes, the exact data points resulting from steps 418, 419, or data points drawn randomly from step 631 may be used. These data points are used as input x's in the execution of the model. These options correspond to the recorded data on which the model was built (step 418), recorded data from the same population of subjects from which the model was built (step 419), and randomly sampled data drawn from a distribution derived from the same population of subjects on which the model was built (step 631).

It is possible that every single component (input, coefficients, error terms) of the equation used as the computational model for forecasting and simulating crowd behavior is randomly drawn from an empirically derived distribution. This process can result in a wide range of predictions from which a probability distribution can be derived. In this way, large numbers of simulations can provide large numbers of simulation output from which to derive probabilities for decision support. In each execution of the simulation, the coefficients for the computational model, the inputs, and the error terms are randomly selected from an empirically constructed distribution. As a result, each execution of the simulation is generating output using a different equation. Therefore, the run model step 325 is capable of generating large amounts of non-redundant simulation output data.

In the analysis of recorded data step 330, which may also be referred to as generation of crowd level data step, analyses are carried out to yield higher order calculated metrics or other derived variables. In a preferred embodiment, the analysis of data step 330 includes calculation of separate individual (closest approach to control force, speed in approaching target) and aggregate crowd metrics at each time step (such as leading edge, trailing edge, centroid locomotion). Data resulting from step 315 are entered into the crowd metrics/model comparison module 125 of the system 100. These processes are carried out in the crowd metrics/model comparison module 125 for both the analysis of observed data collected in the laboratory (step 330) and the model prediction data set calculated from the running of the computation.

In a preferred embodiment the recorded data from the laboratory ideally is that data subset was set aside for this purpose, that is data from step 419 of FIG. 4

Analysis of Model Predicted Data Step 331.

The analysis of model predicted data step 331 parallels the analysis of the recorded data, in that it may include crowd level data; analyses are carried out to yield higher order calculated metrics or other derived variables. In a preferred embodiment, the analysis of data step 331 also includes calculation of separate individual (closest approach to control force, speed in approaching target) and aggregate crowd metrics at each time step (such as leading edge, trailing edge, centroid locomotion). Data resulting from step 325 are entered into the crowd metrics/model comparison module 125 of the system 100. These processes are carried out in the crowd metrics/model comparison module 125 for both the analysis of observed data collected in the laboratory (step 330) and the model prediction data set calculated from the running of the computation (step 331).

In a preferred embodiment the model predicted data are those resulting from step 633 of FIG. 6, when inputted with the recorded data also resulting from step 419.

The results from step 330 are aggregate crowd level metrics calculated from measures of actual human behavior. The results from step 331 are predictions of crowd level metrics generated by inputting identical starting values into the model and running the simulation.

Outputs from steps 330 and 331 of FIG. 2B are then sent to statistical processes that yield mathematical comparisons between the observed and predicted data (step 335) and a graphical display that allows for graphical comparisons between the observed and predicted data (step 340).

Compare Step 335

In the previous run model step 325, several candidate computational models may result, depending on the methods used to generate the stochastic components and the stochastic components that were or were not included. Therefore, steps 335 (compare) and 340 (display) are included to select the computational model that most accurately predicts crowd human behavior. Standard model fit statistics, including but not limited to K-S goodness of fit statistics, are used to compare and evaluate the candidate computational models, at step 335. Graphical methods can also be used to compare and evaluate candidate models, especially for the preferred embodiment using locomotion data.

Other approaches included behavioral science analytical methods that provide statistical support for hypotheses of no differences between groups. Traditional null hypothesis testing statistics are not appropriate for validity tests of the computational model. In contrast, newer Bayesian statistical analyses are appropriate for computational model validity testing because they provide analyses that can be used to support a decision of no differences between the data recorded in the laboratory (step 330) and the calculated predicted data (step 331).

The K-S goodness of fit results can be used to determine how similar the simulation output mirrors the crowd behavior in the laboratory. Distributions of outputs from the simulation are compared with distributions of data from the laboratory. For these purposes, data that is used for this validation phase is ideally a different set of data than was used to generate the mathematical model, the distributions of parameters, and the computational model.

Display Step 340

Step 340 displays graphically the data resulting from step 330. The data recorded in the laboratory and the data predicted by the model are displayed side by side. In a preferred embodiment the display step 340 displays the time plots of the simulated and observed data, allowing for a side by side view of movement patterns.

Optimal Decision Point Step 345

The decision as to the optimal model is based on the statistical result outcomes of the compare step 335 and an evaluation of the graphs in the display step 340. As with the down selection to the optimal mathematical model, and as illustrated by decision step 345, steps 335 and 340 may go through several iterations to identify the optimal computational model. The optimal computational model is then used as the analytical basis of the simulation tool to be developed for use by commanders.

Model Selected Step 350

The model is selected as the optimal model includes several components. The first is the equations or set of equations such as from step 524 and step 530 that were identified as optimal in step 345, that is, as having computations that yield the predictions of crowd behavior closest to the recorded data on crowd behavior. The model selected at step 350 also includes distributions of components of those equations, such as the distribution of coefficients, distributions of errors, constants, or input x's required for computations using the equations, resulting from step 627 and step 631. The selected model further includes the sequence in which these calculations are performed.

Design of Simulation Procedures Step 355

Simulation is the running of the model. Computations are executed using the model selected at step 355 (equations and distributions and sequencing of computations) and inputting numbers reflecting characteristics of the situation to be simulated.

Input numerical values that reflect the situation to be simulated can be such variables as number of control force that are available or the range of the non-lethal weapons that are available to the commander. Output predictions of behaviors are calculated by using the optimal model. Because the equations of the model will vary due to the stochastic process of drawing coefficients from distributions, large numbers of computations can be executed resulting in varying outputs. So, by inputting the same numerical values, the output computations will vary.

When large numbers of the computations are run, that is, the simulation is run many times, a probability distribution of these different outputs can be created. So, in the present example, the inputs to the model are number of control force and range of weapon. Performing these calculations with these inputs 100 times may predict that the crowd will run away 15 times this calculation is performed and predict that the crowd will advance 85 times. Based on this prediction, the forecast would be that under these conditions the model calculates that there is a 15% chance that the crowd will run away. The results of the calculations may be numbers reflecting measures or metrics of behavior(e.g., number of rocks thrown, stand-off distance) or numbers indicating state (1 equal riot, 0 no riot) or other results of computations that are indices reflecting crowd behavior.

In step 355, these simulation processes, specifically, the programming that executes these steps are developed. In essence, the process is to write the code to accept new inputs into the model, to execute the model many times (more than a 100 times).

Creation of a Graphical User Interface Step 360

The results of the previous steps of system 100 and method 300 can be called quantitative means for forecasting crowd behavior. Numerical values and equations are used to calculate the probabilities of the occurrence of crowd behaviors.

The results of the previous steps of system 100 and method 300 are numerous. One such result is a set of variables that can be used to predict behavior (for example, number of people in crowd, number of control force, non-lethal weapons present). Other results are distributions of equation components (for example, coefficients and error terms). Another result is sets of distributions of inputs that can be used to populate the equation components. Finally, method 300 yields sets of serial equation configurations, that can be used to calculate predictions when populated with input values.

The present forecasting tool is then based on using these sets of equations and inputs to the equations to calculate and predict crowd behavior. The equations used for predictions are configured based on user input to the computer forecasting tool.

Graphical user interfaces are designed at step 360 to translate information needs, predictions, and inquiries into an inquiry answerable by the forecasting tool. Menus and selections are in a language that is operationally relevant, so that the inputs and selections are matched to the conceptual model underlying the mathematical and computation model. The sets of variables identified as predictors make up the menus for inputs. Outputs are configured in a way to make the information tactically relevant and actionable. Configuration of selection menu of inputs and display of information on outputs is based on the first step of data collection.

The following Table 1 shows the parallels among the data collected, mathematical model, computational model, and the resulting simulation tool graphical user interface. Process 300 results in an alignment of the tool options and functions with the original tactical scenario, through derivation of mathematical and computational models and simulation tools based on crowd behavioral data collected in experimentation.

TABLE 1

| Real World | | | | |
|---|---|---|---|---|
| Tactical | | Mathematical | Computational | |
| Situation | Experimentation | Modeling | Modeling | Simulation Tool |
| Context | Testbed | Set of predictors | Set of x's and | Menus for |
| | | and predictions | y's | Inputs |
| What Soldier | Independent | Predictor Variables | x's | User |
| knows or | Variables, other | (predictors, | | Submissions to |
| controls about | recorded data | mediators, | | the simulation |
| the tactical | | moderators, | | tool |
| situation | | covariates) | | |
| What the Soldier | Dependent | Predicted Variables | y's | Simulation Tool |
| wants to know | Variables | | | Outputs |
| or predict (How | | | | |
| the targets | | | | |
| behave) | | | | |
| Commander's | Dependent | Predicted Variables | y's | User |
| desired | Variables | | | Submissions to |
| outcomes | | | | the simulation |
| | | | | tool |
| What actions | Independent | Predictor Variables | x's | Simulation Tool |
| should be taken | Variables, other | (predictors, | | Outputs |
| to achieve | recorded data | mediators, | | |
| desired | | moderators, | | |
| outcomes | | covariates) | | |

An example of alignment in step 350 can be as follows. In theater, a commander may want to know for a particular operation the optimal number of personnel to assign to control an area of a certain dimensions, holding a certain number of people in a crowd, given a particular weapon with known range and effect.

This scenario is taken into a laboratory through a design of an experiment that collects data on the relationship between number of control force, number in crowd, dimensions of area to be controlled, and weapon range with crowd responses. That is, an experiment is set up to derive the equations that can predict crowd behavior based on the variables of number of control force, number in crowd, dimension of the area, and weapon range.

The mathematical and computational models are derived from data on human behavior in these analogous situations. The mathematical and computational model are then selected based on quantitative verification and validation for inclusion in an application for use in mission planning and decision support.

In the resulting software application, the options for inputs will prompt the commander to enter in values as to the number in the crowd, the dimensions of the area to be controlled, and the weapon range. As an example, the output would be then a calculation of the required number of personnel to control a crowd in that situation with the given weapon, as well as the confidence or uncertainty associated with that prediction. More than one format for inquiry can be accommodated.

Of special note is the ability of the present system 100 and method 300 to accommodate as input values characteristics of other populations as described herein in connection with step 631 of FIG. 6. For example, in one embodiment, the simulation tool will have embedded within the software culture or population specific distributions of possible inputs for calculations. Depending on what the user selects as the population or culture of interest, the simulation tool will use the appropriate distribution for drawing x values for calculating predictions.

The simulation tool will have the model or models that have been identified through system 100 and method 300 as the optimal model for forecasting crowd versus control force situations. There may be several optimal models within the tool because the characteristics of different tactical scenarios can be expected to require separate models (for example, crowd in urban versus rural settings, embassy protection versus humanitarian aid).

These models are equation configurations. That is, based on user input, equations are configured and calculations are performed to predict values which are analyzed to provide forecasting of crowd behavior.

The software tool also contains distributions relevant to the functions of the models. These include a distribution of possible x values for use in calculations in the execution of the model. These values may be derived from experimentation, or derived from open data, as described herein in connection with step 631 of FIG. 6. In addition, discrete values of x's and y's may be stored corresponding to known values associated with menu options. For example, different non-lethal weapon options may be available for selection by the user; known discrete ranges of those weapons would be stored in the program.

Alternatively, input distributions can be generated from any data source providing the parameters for creating a distribution (e.g., a mean and standard deviation). This feature allows computational models great extensibility, especially with respect to cultural difference in human behavior. This feature has an impact on step 350 of FIG. 2B, in the creation of a graphical user interface for commanders using the forecasting tool.

That is because some segments of cross cultural research will frequently publish means and standard deviations for characteristics that across different culture groups. Based on these publish parameters, distributions of inputs can be derived for different culture groups. For example, normative data for different countries can be published in open literature on characteristics that may be relevant to behavior in crowds (e.g., response to authority, pain tolerance)

Therefore in the graphical user interface for system 400 and method 500, the development of these mathematical and computational models creates a means for selecting population groups for forecasting. The selection of options of the population groups will then randomly select from the appropriate distribution of values corresponding to that population group.

This feature allows the computational models to be useable in forecasting for populations other than that used for building the model. The distribution of inputs appropriate for the population or cultural group can then be used in the computational model underlying the simulation or forecasting using system 400 and method 500.

Performing the simulation is essentially a process based on modifications of steps 325, 331, and 340 of method 300 (FIG. 2) and using the simulation module 120, the crowd metrics/model comparison module 125, and the display module 130 of system 100 (FIG. 1).

Based on the method 300 and the alignment of variables, the simulation tool and the graphical user interface is configured to answer three general types of inquiries. The first inquiry for a forecasting of a crowd behavior in a single set of conditions. The second inquiry is for a comparison of forecasts for crowd behavior in multiple condition options (first, subsequent, last). The third inquiry a request for recommended actions to maximize the probability of some desired outcome.

An example of the first kind of inquiry is “How close will the crowd get to the protected site if the control forces uses Weapon A?”.

An example of the second kind of inquiry is “I have Weapon A, B, and C. How close will the crowd get to the protected site if the control force uses Weapon A, or Weapon B, or Weapon C?”.

An example of the third kind of inquiry is “What weapon do I use to keep the crowd 100 m or more away from the protected site?”.

FIG. 7 illustrates method 400 that outlines the functions and processes of the simulation tool that occur when a user operates the simulation tool of the present invention. FIG. 8 shows the logical flow chart 500 of the method 400.

User Input Module 405

A user input module 405 accepts user data through the graphical user interface created in step 360.

Simulation Module 410

The simulation module 405 selects the appropriate models and numerical values used to answer the user's inquiry as it will be explained in connection with step 510 of FIG. 9. The simulation module 405 then executes all the calculations that have been selected.

Analysis Module 415

The analysis module 410 calculates and creates higher order aggregate data, summary statistics, or other mathematical transforms, distributions, and probability densities. This function of the analysis module 410 is generally similar to the analysis of model predicted data step 331 (FIG. 2B).

Interpretation Module 420

The program then interprets the predicted values, in terms of determining the probability of the range of behaviors appropriate to the selections of the user.

Display Module 425

The display module 420 then displays the forecast according to the menu selections of the user. The display may be the textual, tabular, or graphical, similar to that described earlier in connection with the display step 340. The graphical display is similar to that of step 340 of FIG. 2B.

Simulation Tool Method 500

System 100 and method 300 develop the model to be used in simulation tools for commanders in order to forecast crowd behavior faced with control forces. The simulation tool method 500 describes the processes involved in using these models in the subsequent simulation tool.

FIG. 8 represents a flow chart for the method or process 500 that underlies the simulation tool.

User Submission Step 505

In using the simulation tool, the user selects the scenario, inputs characteristics of the crowd versus control force situation that are known or controlled, and selects forecasting of interest and the preferred display of the results of the simulation. This is done through the graphical user interface developed, for example, at step 350 of FIG. 25.

Run Simulation Step 510

At the run simulation step 510, process 500 selects the models that are appropriate for the inquiry. The available models are developed by, and described in connection with system 100 and method 300. Numerical values used in the equations are also selected at this step 510, either from distributions or discrete values corresponding to user submissions from the tool's menu.

The distributions for parameters and errors are a result of step 627 of FIG. 6, and the distributions of inputs are a result of step 631 of FIG. 6, as described herein.

The processes of the run simulation step 510 differ according to the type of inquiry submitted by the user (901 of FIG. 9). FIG. 9 is a flow chart of the run simulation step 510 of FIG. 8, for determining the appropriate process flowchart steps to follow (step 915, or step 920, or step 925). FIG. 10 further illustrates the steps of sub-process 915 of process 510 (FIG. 9) for the first kind of user inquiry, as described earlier in connection with the creation of a graphical user interface step 350 (FIG. 2B). FIG. 11 (FIGS. 11A, 11B, 11C) shows the process for the second kind of inquiry as described earlier in connection with the creation of a graphical user interface step 350 (FIG. 2B). FIG. 12 shows the process for the third kind of user inquiry, as described earlier in connection with the creation of a graphical user interface step 350 (FIG. 2B).

FIG. 10 shows the process for selection of calculations for the forecasting behavior from a single configuration of variables, step 915 of FIG. 9. As depicted in FIG. 10, the model selection (at step 1005), input x's (at step 1010), parameters (at step 1015), and error terms (at step 1020) for the equations are selected. Process 915 concatenates the terms in the equation to be used to calculate predictions at step 1025. Process 915 further generates the list of equations to be calculated to yield the distributions used for forecasting behavior or predicting locomotion paths, at step 1030.

FIGS. 11A, 11B, and 11C respectively illustrate the processes 1110, 1120, 1130 for selecting the calculations for the forecasting of behavior or predicting locomotion paths from more than one configuration of variables. These processes 1110, 1120, 1130 for calculation selection are similar to that of a single configuration 915 (FIG. 10) and are respectively carried out separately for each of the configurations, as illustrated in FIGS. 11A, 11B, and 11C, with process 1110 of FIG. 11A selecting model option 1 (step 1115), process 1120 of FIG. 11B selecting subsequent model options 2-n (step 1125), and process 1130 selecting the last model option n(step 1135).

FIG. 12 illustrates the process 925 of selecting the calculations for recommendations for actions to maximize the probability of a desired outcome. While the models developed in system 100 and method 300 are used, the calculations differ because the equation is solved for an x value. That is, the desired outcome, y, is determined by user menu submission (step 901), a subset of x's inputs are determined by user menu submissions. The equations to be used to calculate predictions are then configured to be solved for the x that maximizes or minimizes the y or so that the y meets certain predetermined criteria.

The selection of the equations for this inquiry type is similar to the first and second inquiry kinds, at steps 1005, 1010, 1015, 1020, 1025, 1030. In addition, step 1215 includes the selection of x's corresponding to the actions/variables that are the subject of the inquiry. The selection of these subject x inputs is configured to identify x values to optimize the probability of the desired outcome. One reasonable configuration is to input the whole range of available values for that x to identify the x values that result in a desired y value.

With reference to FIG. 9, step 930 performs the lists of calculations resulting form steps 915, 920, and 925.

Analysis of Results of Simulation Step 515

Returning to FIG. 8, process 500 performs the step of analyzing the results of the simulation at step 515, and creates higher order aggregate data, summary statistics, or other mathematical transforms, distributions and probability density graphs of output values calculated at step 510.

Interpretation of Analyses Step 520

At step 520, process 500 receives from step 515 the analyses of the output from the calculations and interprets the results (e.g., aggregate summaries, descriptive statistics, distributions or probability densities) to arrive at the information to be returned to the user. The information returned to the user depends on the inquiry type submitted by the user.

The information to be returned to the user who submitted an inquiry for forecasting for a single set of conditions, is the forecasted crowd behavior and the probability associated with the forecasted behavior occurring.

The information to be returned to the user who submitted an inquiry for forecasting for multiple conditions, is the forecasted crowd behavior and the probability associated with the forecasted behavior occurring for each of the conditions.

The information to be returned to the user who submitted an inquiry for actions to maximize the probability of a desired outcome is the recommended item/action, and the probability associated with the desired behavior occurring.

Display Step 525

At step 525, process 500 displays the result (or requested information) to the user. This is done either by text, table, graph, or any other suitable means.

Although the present system 100 and method 300 have been described in connection with one exemplary application, it should be clear that other modifications may be made to the system 100, method 300, system 400, and method 500 without departing from the spirit and scope of the present invention.

Embodiments of the present invention can take the form of an entirely hardware embodiment or an embodiment containing both hardware and software elements. In a preferred embodiment, the invention is implemented in hardware. For the purposes of this description, a computer-usable or computer readable medium can be any apparatus that can contain, store, communicate, propagate, or transport the program for use by or in connection with the instruction execution system, apparatus, or device, including but not limited to smart phones. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method for modeling a crowd response to a control force, comprising:
collecting empirical data of real world human behavior in response to the control force, in a controlled setting; wherein the empirical data comprises physiological or electrophysiological samples of members from the crowd;
processing the collected empirical data to derive numerical values in order to quantify the real world human behavior;
configuring the derived numerical values in a structured arrangement in preparation for processing;
building mathematical models by using the collected data;
using the models to generate output predicted data;
statistically comparing between the collected empirical values and the output predicted data for each mathematical model, in order to determine a best fit mathematical model;
applying the best fit mathematical model to start conditions to generate the output predicted data; and
rendering the output predicted data.

2. The modeling method according to claim 1, wherein rendering the output predicted data includes displaying the output predicted data to a user.

3. The modeling method according to claim 1, wherein the controlled setting includes a laboratory setting.

4. The modeling method according to claim 3, wherein the laboratory setting includes a systematic configuration of operationally relevant variables.

5. The modeling method according to claim 1, wherein the control force includes a non-lethal weapon.

6. The modeling method according to claim 1,
further comprising; processing collected empirical data in order to be entered into subsequent mathematical processes that build the models.

7. The modeling method according to claim 1, wherein the structured arrangement includes any one or more of: a file, a table, and a matrix.

8. The modeling method according to claim 1, wherein collecting the empirical data includes designating target areas as sources of field forces that are reflected in locomotion of crowd members toward and away from the target areas.

9. The modeling method according to claim 8, wherein collecting the empirical data includes using motion capture data during the locomotion of the crowd members.

10. The modeling method according to claim 9, further including indexing the field forces as any of: attraction forces and repulsion forces, in response to the motion capture data.

11. The modeling method according to claim 9, further including measuring the field forces based on the motion capture data.

12. The modeling method according to claim 8, wherein the locomotion of crowd members includes a locomotion path for the crowd as a whole and a locomotion path for each member of the crowd.

13. The modeling method according to claim 1, wherein determining the best fit mathematical model includes using statistical and graphical comparisons.

14. The modeling method according to claim 9, wherein collecting the empirical data includes using motion capture data during the locomotion of the crowd members includes using comprising any one or more of: a video recording, an audio recording, a real time visual observation, surveys, and questionnaire.

15. (canceled)

16. (canceled)

17. A method for forecasting a crowd response to a control force, comprising:
collecting input information from a user:
translating the collected input user information into numerical values for input into models:
selectively loading the models for simulation processes:
calculating simulation outputs by inputting the translated collected input user information into the loaded models;
calculating descriptive statistics derived from the simulation outputs;
statistically comparing among the simulation outputs;
processing the results of the statistics to generate a forecast; and rendering the forecast.

18. The forecasting method according to claim 17, wherein translating the collected input user information includes a value selection process.

19. The forecasting method according to claim 17, wherein calculating the simulation outputs includes using a simulation process.

20. The forecasting method according to claim 17, wherein rendering the forecast includes displaying the forecast to the user.

21. A system for forecasting a crowd response to a control force, comprising:
a user input module for collecting input information from a user;
a translation module for translating the collected input user information into numerical values for input into models;
a simulation module for selectively loading the loaded models;
a simulation module for calculating simulation outputs by inputting the translated collected input user information into the models;
an analysis module for calculating descriptive statistics derived from the simulation outputs of the simulation module, and for statistically comparing the outputs from the simulation module;
an interpretation module for processing the results of the statistics to generate a forecast; and
a display module that renders the forecast.

22. A computer program product that includes a plurality of sets of instruction codes stored on a computer readable medium for forecasting a crowd response to a control force, the computer program product comprising:
a first set of instruction codes for collecting input information from a user;
a second set of instruction codes for translating the collected input user information into numerical values for input into models;
a third set of instruction codes for selectively loading the models;
a fourth set of instruction codes for calculating simulation outputs by inputting the translated collected input user information into the loaded models;
a fifth set of instruction codes for calculating descriptive statistics of the simulation outputs of the simulation module;
a sixth set of instruction codes for statistically comparing the outputs from the simulation module;
a seventh set of instruction codes for processing the results of the statistics to generate a forecast; and
an eighth set of instruction codes for rendering the forecast.

23. The method of claim 1 wherein the physiological samples is selected from the group consisting of blood, urine, and saliva.

24. The method of claim 1 wherein the electrophysiological sample is selected from the group consisting of electrocardiographic, electroencephalographic, and electrodermal samples.
